(19) United States
(12) Patent Application Publication
(10) Pub. No.: US 2020/0210120 A1
(43) Pub. Date: Jul. 2, 2020

(54) DISTRIBUTED PRINTING SYSTEM AND INFORMATION PROCESSING DEVICE

(71) Applicant: KONICA MINOLTA, INC., Tokyo (JP)

(72) Inventor: Kazuhiko IMANISHI, Tokyo (JP)

(73) Assignee: KONICA MINOLTA, INC., Tokyo (JP)

(21) Appl. No.: 16/724,294

(22) Filed: Dec. 22, 2019

(30) Foreign Application Priority Data
Dec. 27, 2018 (JP) 2018-244345

(51) Int. Cl. G06F 3/12

(52) U.S. Cl. CPC G06F 3/1238; G06F 3/1296; G06F 3/1291; G06F 3/126

(57) ABSTRACT

Distributed printing has not been capable of being performed by flexibly correcting a printing device to which a user instructs printing. A printing management server has an information setting unit setting, to a plurality of jobs to which the user authentication information of a user is set and having relationship properties, relationship information shared among the plurality of jobs, a job delivery unit delivering the different jobs to the respective plurality of printing devices, and a distributed printing instruction unit instructing, to the printing device designated by the user, distributed printing on the basis of the job having the matched relationship information. Each of the printing devices includes a job execution unit extracting, from a storage unit, the job to which the user authentication information matched with the user authentication information authenticated as valid by an authentication unit and the matched relationship information are set, and executing the job.

### CROSS-REFERENCE TO RELATED APPLICATIONS

The entire disclosure of Japanese Patent Application No. 2018-244345, filed on Dec. 27, 2018, is incorporated herein by reference in its entirety.

### BACKGROUND

### Technological Field

The present invention relates to a distributed printing system and an information processing device.

### Description of the Related Art

As a method for printing a confidential document, there is typically so-called security printing that controls printing to be started when a user introduces a printing job to a printing device, and then performs user authentication (or password input) on the printing device into which he/she has actually introduced the job. At the time of starting the security printing, the user authentication is received on the printing device that outputs the sheet, assuring that the user is present before the printing device. Thus, information leak, such as peeping at the printed sheet by other persons, can be prevented.

As a technology used for distributed printing, for example, Patent Literature 1 (Japanese Unexamined Patent Application Publication No. 2016-143286) discloses a technology in which a printing device to which a user has inputted user authentication information is allowed to be a base point, and only printing devices capable of being looked over simultaneously with the printing device at the base point are restricted to be capable of being set to the distribution destinations of printing jobs.

### CITATION LIST

### Patent Literature

Patent Literature 1: Japanese Unexamined Patent Application Publication No. 2016-143286

### SUMMARY

In the technology disclosed in Patent Literature 1, the printing devices (distribution destinations) executing printing within the range that can be viewed by the user are previously designated, so that the security can be secured. However, each time the number of printing devices to which printing is distributed is increased to be more than the range that can be viewed by the user, or each time the arrangement of the printing devices in the office is changed, the printing devices that are the distribution destinations are required to be corrected. Consequently, the distributed printing has not been capable of being flexibly performed.

The present invention has been made in view of such conditions and an object of the present invention is to enable distributed printing having high convenience.

To achieve at least one of the abovementioned objects, according to an aspect of the present invention, a distributed printing system reflecting one aspect of the present invention comprises a printing management server, and a plurality of printing devices connected to the printing management server via a network.

The printing management server has an information setting unit setting, to a plurality of jobs to which the user authentication information of a user who has introduced a job is set and having relationship properties, relationship information shared among the plurality of jobs, a job delivery unit delivering the different jobs to the respective plurality of printing devices, and a distributed printing instruction unit instructing, to the printing device designated by the user among the plurality of printing devices, distributed printing on the basis of the job having the matched relationship information.

Each of the printing devices has a storage unit storing the job received from the job delivery unit, an authentication unit authenticating the user on the basis of the inputted user authentication information, and a job execution unit extracting, from the storage unit, the job to which the user authentication information matched with the user authentication information authenticated as valid by the authentication unit and the matched relationship information are set, and executing the job.

An information processing device reflecting one aspect of the present invention comprises an information setting unit setting, to a plurality of jobs to which the user authentication information of a user who has introduced a job is set and having relationship properties, relationship information shared among the plurality of jobs, a job delivery unit delivering the different jobs to the respective plurality of printing devices connected via a network, and a distributed printing instruction unit instructing, to the printing device designated by the user among the plurality of printing devices, distributed printing on the basis of the job having the matched relationship information.

Problems and configurations other than the above will be apparent from the description of the following embodiment.

### BRIEF DESCRIPTION OF THE DRAWINGS

The advantages and features provided by embodiments of the invention will become more fully understood from the detailed description given hereinbelow and the appended drawings which are given by way of illustration only, and thus are not intended as a definition of the limits of the present invention:

FIG. 1 is an outline diagram illustrating the configuration example of a distributed printing system according to an embodiment of the present invention;

FIG. 2 is a block diagram illustrating the inner configuration example of a printing management server according to an embodiment of the present invention;

FIG. 3 is a block diagram illustrating the hardware configuration example of the printing management server according to an embodiment of the present invention;

FIG. 4 is a block diagram illustrating the inner configuration example of a printing device according to an embodiment of the present invention;

FIG. 5 is a hardware configuration diagram illustrating the configuration example of the main portion of the printing device according to an embodiment of the present invention;

FIG. 6 is an explanatory view illustrating an example of a process for dividing a secure job and transmitting divided jobs to a plurality of printing devices according to an embodiment of the present invention;

FIG. 7 is an explanatory view illustrating an example of the divided jobs distributed to the plurality of printing devices and the groups thereof according to an embodiment of the present invention;

FIG. 8 is an explanatory view illustrating an example in which the jobs accumulated in queues are not arranged in the job ID order according to an embodiment of the present invention;

FIG. 9 is a flowchart illustrating an example of a process performed on each device of the distributed printing system according to an embodiment of the present invention;

FIG. 10 is a flowchart illustrating an example of the process of the printing management server and another printing device according to an embodiment of the present invention;

FIG. 11 is a user interface diagram illustrating the display example of a selection screen for the typical job according to an embodiment of the present invention;

FIG. 12 is a user interface diagram illustrating the display example of a selection screen capable of displaying the jobs stored in other printing devices according to an embodiment of the present invention;

FIG. 13 is a user interface diagram illustrating the display example of the selection screen displaying only the jobs having the same group ID according to an embodiment of the present invention;

FIG. 14 is a user interface diagram illustrating the display example of the selection screen displaying the jobs to which the same group ID as the job that is a start point is set and the jobs related to the job that is the start point according to an embodiment of the present invention; and

FIG. 15 is a user interface diagram illustrating the display example of a printing result screen according to an embodiment of the present invention.

### DETAILED DESCRIPTION OF EMBODIMENTS

Hereinafter, an embodiment of the present invention will be described with reference to the accompanying drawings. Components having substantially the same functions or configurations herein and in the drawings are indicated by the same reference numerals, and the overlapped description thereof is thus omitted. The scope of the invention is not limited to the disclosed embodiment.

### An Embodiment

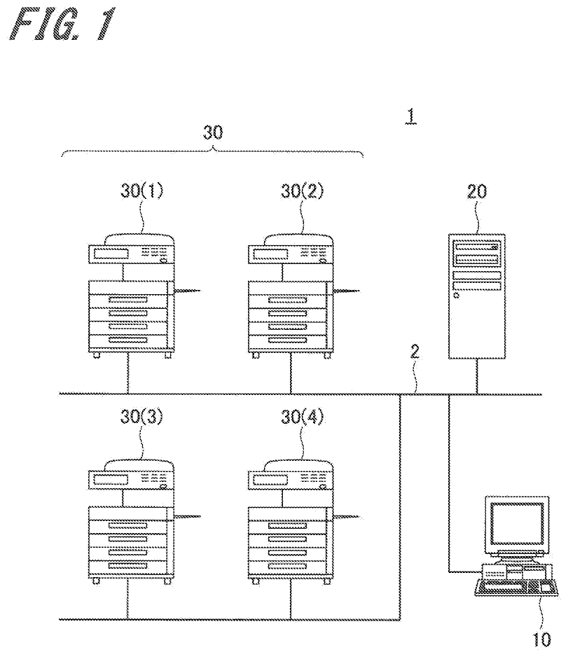

FIG. 1 an outline diagram illustrating the configuration example of a distributed printing system 1.

The distributed printing system 1 includes a client PC 10 (an example of an information processing device), a printing management server 20, and a plurality of printing devices 30(1) to 30(4), which are connected to a network 2. When not discriminated, the printing devices 30(1) to 30(4) are collectively called a printing device 30. The network 2 is, for example, a LAN (Local Area Network) and the like.

When the secure printing of a confidential document is performed by using the distributed printing system 1, a user operating the client PC 10 sets a security printing mode from a setting screen for a job displayed on the client PC 10. And, the user inputs, from the setting screen, a user ID and a password that are user authentication information, and can thus set the user authentication information to the job. It should be noted that the user authentication information that is information inherent to the user who has logged in the client PC 10 may be automatically set to the job by a printer driver and the like when the user introduces the job by using the client PC 10. Thereafter, the client PC 10 performs a process for transmitting, through the network 2 to the printing management server 20, the job to which the user authentication information is set.

Here, the user can designate distributed printing in which one or a plurality of jobs are distributed to and printed on each of the plurality of printing devices 30. When the user designates the distributed printing, the client PC 10 notifies, to the printing management server 20, a message that the distributed printing has been designated, in addition to the data of the job.

The printing management server 20 accumulates the job received from the client PC 10. And, the printing management server 20 divides the job to generate divided jobs such that the divided jobs can be optimally distributed to the plurality of printing devices 30 by taking printing per copy, printing per page, color/monochrome printing, and the like into account, in consideration of the performance of the respective printing devices, the amount of sheets left, the job in standby, and the like. In that case, the printing management server 20 assigns, to the divided job, a new job ID different from the job ID of the undivided job (the original job). For example, when “1” is assigned as the job ID to the undivided job, the job IDs “1-1” and “1-2” are respectively assigned to the divided jobs obtained by dividing this job into two. The new job ID assigned to the divided job is a number that is unique for each job. Also, the printing management server 20 holds the information of a parent job that is the division source (identification information, such as the job name and the job ID) and child information representing the number that each divided job has (for example, the second among the five divided jobs, and the like) together, and manages the jobs.

Thereafter, the printing management server 20 delivers the divided job to the appropriate printing device 30. And, when receiving a printing instruction from the user, the printing management server 20 instructs printing start to each of the printing devices 30 that have received the divided jobs. The printing instruction from the user is performed by the operation on the client PC 10, or by operating the printing device 30 by the user.

After receiving the job from the printing management server 20, the printing device 30 performs printing on the basis of the instruction of the printing start, and discharges, to the sheet discharge tray, the sheet on which the image is printed. It should be noted that the printing device 30 may be standby for printing until the user logs in the printing device 30, and start printing after the printing instruction is performed by the user.

Also, the printing device 30 connected to the network 2 can communicate with other printing devices 30. Thus, when the printing device 30 to which the user has inputted the authentication information executes the job, the other printing devices 30 automatically start job execution (also called “job printing”). However, depending on the jobs stored in the other printing devices 30, the other printing devices 30 may be standby for printing until the explicit printing instruction from the user is performed.

In FIG. 1, the printing management server 20 is illustrated to be separated from the client PC 10, but for the system configuration, the client PC 10 may be equipped with the server function of the printing management server 20. In this case, the client PC 10 is operated as the printing management server 20.

### The Inner Configuration of the Printing Management Server

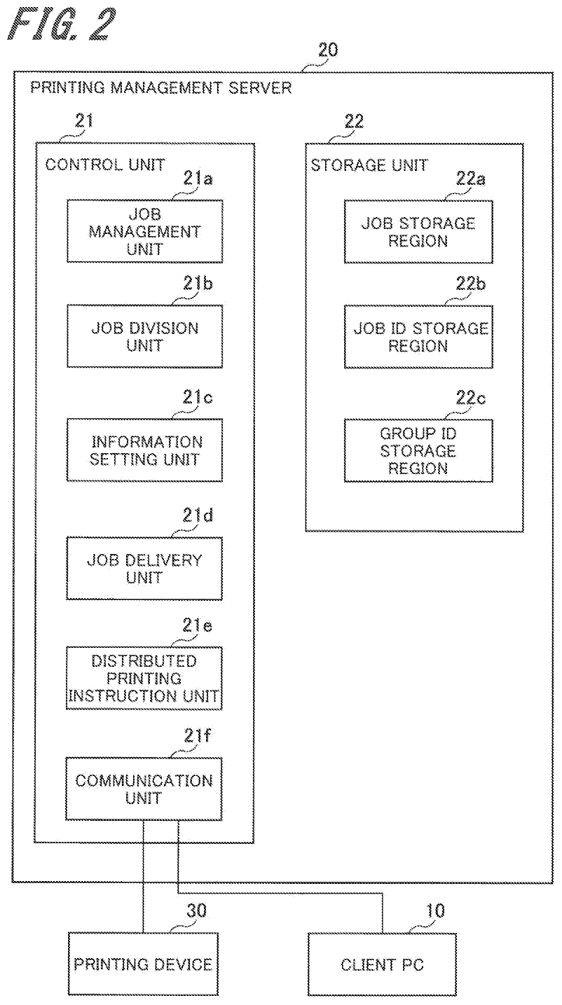

FIG. 2 is a block diagram illustrating the inner configuration example of the printing management server 20.

The printing management server 20 includes a control unit 21 and a storage unit 22.

The control unit 21 includes a job management unit 21a, a job division unit 21b, an information setting unit 21c, a job delivery unit 21d, a distributed printing instruction unit 21e, and a communication unit 21f.

The storage unit 22 stores the job and the divided job in a job storage region 22a, and also has a job ID storage region 22b and a group ID storage region 22c.

The job management unit 21a sets, to the job received from the client PC 10 via the network 2 by the communication unit 21f, the job ID (an example of job identification information) as information that can uniquely identify the job, and manages the job. The job received from the client PC 10 is stored in the job storage region 22a of the storage unit 22. Also, the job ID set to the job is stored in the job ID storage region 22b provided in the storage unit 22. It should be noted that when the job ID has already been set at the time of receiving the job from the client PC 10, the job management unit 21a stores the job ID extracted from this job in the job ID storage region 22b.

The job division unit 21b divides the job stored in the job storage region 22a into any number of jobs. The job division unit 21b divides the job, for example, on the basis of each page, each data amount, and each sheet type. For example, in the case of the job in which a large number of pages are required to be printed, the job is divided such that a plurality of divided pages can be separately printed on the plurality of printing devices 30.

The information setting unit 21c sets, to a plurality of jobs to which the user authentication information of the user who has introduced the job is set and having relationship properties, a group ID (an example of relationship information) shared among the plurality of jobs. The group ID set to the job is stored in the group ID storage region 22c provided in the storage unit 22. The presence or absence of the relationship properties between the jobs is determined with respect to both of the undivided job and the divided job. Also, the information setting unit 21c can set the user authentication information and the group ID to each divided job.

The group ID represents the relationship properties between the plurality of jobs in the distributed printing. For example, the information setting unit 21c can represent the relationship properties of the parent-child relationship between the undivided job (parent) and the divided job (child) by the group ID. For example, when the job IDs are “1-1” and “1-2”, the parent-child relationship in which the job ID of the undivided job is “1”, and this job is divided to set the job IDs “1-1” and “1-2” is found.

In this way, the information setting unit 21c sets the group ID on the basis of at least one or more information among the execution validity or invalidity of the distributed printing with respect to the job, the name of the job, the user authentication information set to the job, the time at which the printing instruction has been performed, the document information of the job, the printing setting information, and the information of the client terminal that has introduced the job.

Here, the specific examples of conditions (1) to (4) in which the information setting unit 21c determines the relationship properties between the plurality of jobs including the divided jobs will be given below.

(1) For the matched particular character string in the job names

### Example

For the matched character string before the dot “.” like distribution_20180918_(exhibition poster).001, distribution_20180918_(exhibition poster).002, and distribution_20180918_(exhibition poster).003 (2) For the matched information of the user who has introduced the job and the matched information of the client PC 10 that has introduced the job

### Example

The job introduced from a user A and the client PC 10 (IP address 192.168.x.xx)

(3) For the matched document and the matched printing setting information of the job

### Example

The document includes a plurality of pages of “A4-sized and full color”, and the printing setting information of the job is “double-sided printing, imposition (4-UP and the like), 1200 dpi, and automatic color”.

(4) For the introduction time of the job within a fixed range

### Example

The job introduced within five minutes after the introduction of the first secure job

Also, the information setting unit 21c may determine the relationship properties by combining a plurality of conditions among the abovementioned conditions (1) to (4). That is, a process is considered in which the information setting unit 21c determines that in the case of the same job name and the same job introducing user, the relationship properties are present, and assigns the group ID to the job. Also, when the plurality of printing devices 30 perform the distributed printing of the job, the information setting unit 21c determines, to the respective jobs divided by the job division unit 21b, that the relationship properties are present, thereby assigning the same group ID. Here, the information setting unit 21c can set the group ID to other jobs to which the group ID is not set.

Actually, even when the jobs are introduced from a plurality of client PCs 10, the printing management server 20 is required to grasp the relationship properties between the respective jobs. Thus, it is appropriate that the process for assigning the group ID after the relationship properties are determined is executed on the printing management server 20.

The job delivery unit 21d delivers the different jobs to the respective plurality of printing devices 30. The job delivery unit 21d delivers both of the undivided job and the divided job.

The distributed printing instruction unit 21e instructs, to the printing device designated by the user among the plurality of printing devices 30, the distributed printing of the job having the matched group ID. Thus, the distributed printing instruction unit 21e can instruct the distributed printing to each of the plurality of printing devices 30 to which the job deliver unit 21d has delivered the jobs. The instruction of the distributed printing is transmitted through the communication unit 21f to the plurality of printing devices 30.

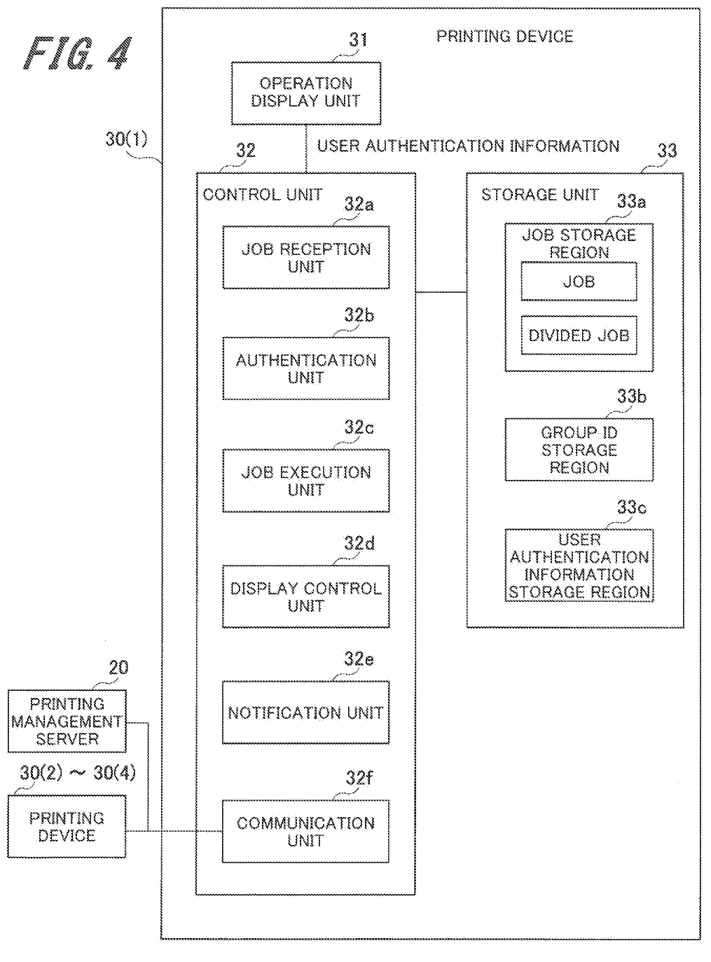

Also, the distributed printing instruction unit 21e confirms, on the basis of execution information notified from the printing device 30, the user authentication information and the group ID set to the job executed by the job execution unit 32c (see FIG. 4 described later) of the printing device 30, and the user authentication information and the relationship information set to the other jobs. And, for the matched user authentication information and the matched relationship information, the distributed printing instruction unit 21e can instruct the distributed printing on the basis of the other jobs to the other printing devices 30 to which the other jobs have been delivered. The execution information is information for notifying, to the printing management server 20, that the printing device 30 has executed one of the jobs to which the certain group ID is set. Also, when receiving the group ID and authentication result information from the printing device 30, the distributed printing instruction unit 21e can also instruct the other printing devices 30 to which the jobs have already been delivered, to execute the jobs having the matched user authentication information and the matched group ID.

### The Hardware Configuration of the Printing Management Server

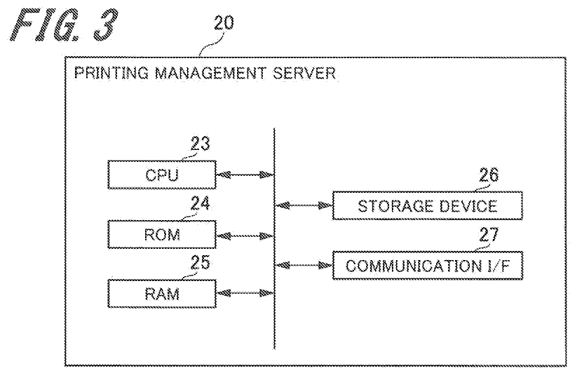

FIG. 3 is a block diagram illustrating the hardware configuration example of the printing management server 20.

The printing management server 20 includes a CPU (Central Processing Unit) 23, a ROM (Read Only Memory) 24, a RAM (Random Access Memory) 25, a storage device 26, and a communication interface 27, and is used as a so-called computer. Each unit in the printing management server 20 is connected via a bus.

The functions of the control unit 21 illustrated in FIG. 2 are achieved by operating the CPU 23, the ROM 24, and the RAM 25. Thus, the control unit 21 is used as an example of a computer controlling the operation of each unit in the printing management server 20.

The CPU 23 reads the program code of software achieving each function according to the present embodiment from the ROM 24, and executes the processes of the job management unit 21a, the job division unit 21b, the information setting unit 21c, the job delivery unit 21d, the distributed printing instruction unit 21e, and the communication unit 21f, which are illustrated in FIG. 2.

The ROM 24 is used as an example of a nonvolatile memory, and stores the program, data, and the like necessary for the CPU 23 to operate.

The RAM 25 is used as an example of a volatile memory, and temporarily stores information (data) necessary for each process performed by the CPU 23.

The storage device 26 includes, for example, an HDD (Hard Disk Drive), and stores the program for the CPU 23 to control each unit, and the program and data of the OS (Operating System), the controller, and the like. Portions of the program and the data stored in the storage device 26 are stored also in the ROM 24. The ROM 24 and the storage device 26 are used as an example of a non-transitory recording medium storing a computer readable program executed by the CPU 23. It should be noted that the non-transitory recording medium storing the computer readable program executed by the printing management server 20 is not limited to the HDD, and may be, for example, a recording medium, such as an SSD (Solid State Drive), a CD-ROM, and a DVD-ROM. In the storage device 26, the job ID storage region 22b, the group ID storage region 22c, various jobs, and the like, which are illustrated in FIG. 2 are stored.

The communication interface 27 includes an NIC (Network Interface Card), a modem, and the like, establishes the connection with each device via the network 2, and executes the transmission and reception of various data. The operation of the communication interface 27 is controlled by the communication unit 21f.

### The Inner Configuration of the Printing Device

Next, the inner configuration example of the printing device 30 will be described with reference to FIG. 4.

FIG. 4 is a block diagram illustrating the inner configuration example of the printing device 30. Here, the configuration example of the printing device 30(1) illustrated in FIG. 1 will be described. It should be noted that all of the other printing devices 30(2) to 30(4) have the same configuration as the printing device 30(1), and the detailed description thereof is thus omitted.

The printing device 30(1) includes an operation display unit 31, a control unit 32, and a storage unit 33.

The operation display unit 31 is, for example, a liquid crystal display device including a touch panel, and is mounted in the upper portion of the printing device 30(1). Thus, the operation display unit 31 can receive the operation input from the user, and display the job stored in the storage unit 33. Accordingly, the user present near the printing device 30(1) can input the user ID and the password (the user authentication information) through the operation display unit 31. On the basis of the contents of this operation input, a display control unit 32d may perform selection to display or not to display, as a printing target, the job to which the same user authentication information is set.

It should be noted that a reading unit (a card reader and the like), not illustrated, connected to the operation display unit 31 may read the user authentication information stored in an IC card that the user carries.

The control unit 32 includes a job reception unit 32a, an authentication unit 32b, a job execution unit 32c, the display control unit 32d, a notification unit 32e, and a communication unit 32f.

The job reception unit 32a receives the job delivered from the printing management server 20 through the network 2. The job reception unit 32a also receives the divided job divided by the job division unit 21b of the printing management server 20. The job and the divided job received by the job reception unit 32a are stored in a job storage region 33a of the storage unit 33.

The storage unit 33 includes the job storage region 33a, a group ID storage region 33b, and a user authentication information storage region 33c.

In the job storage region 33a, for example, two types of jobs of the undivided job and the divided job, which are received from the printing management server 20 are stored.

In the group ID storage region 33b, the group ID representing the relationship properties between the plurality of jobs is stored.

The authentication unit 32b authenticates the user on the basis of the user authentication information inputted from the operation display unit 31. In this authentication, the authentication unit 32b determines whether the user authentication information stored in the user authentication information storage region 33c and the user authentication information set to the job are matched. For the matched user authentication information, the authentication unit 32b determines “valid”, and allows the process, such as the job execution. For the non-matched user authentication information, the authentication unit 32b determines “invalid”, and does not allow the subsequent process.

The job execution unit 32c extracts, from the storage unit 33, the job to which the user authentication information matched with the user authentication information authenticated as valid by the authentication unit 32b and the matched group ID are set, and executes the job. Here, the job execution unit 32c can determine, on the basis of the contents of the operation input performed through the operation display unit 31, whether or not the job to which the same user authentication information is set is executed. For example, even when the job having the different group ID is stored in the job storage region 33a, the execution of the job having the different group ID by the job execution unit 32c when allowed by the user, is enabled.

When the job execution unit 32c starts the execution of the job, the operation of each unit (a sheet conveying unit, a primary transfer unit, a secondary transfer unit, a fixing unit, and the like) related to printing in the printing device 30(1) is controlled to perform the printing according to the setting information of the job. Here, the job execution unit 32c can also instruct the other printing devices 30 to execute the jobs in which the user authentication information and the group ID are matched with the user authentication information and the group ID set to the job to be executed, respectively, the jobs being stored in the other printing devices 30. In this case, the execution of the instructed jobs is started on the other printing devices 30.

The display control unit 32d controls the screen displayed on the operation display unit 31. Thus, the display control unit 32d can control the information displayed on the screen, the display form of the screen, and the like, and allow the operation display unit 31 to display the screen that can be operation inputted by the user, thereby promoting the operation input.

The notification unit 32e notifies, through the communication unit 32f to the printing management server 20, the execution information related to the job executed by the job execution unit 32c. Also, the notification unit 32e can also notify, through the communication unit 32f to the printing management server 20 or the other printing devices 30, the group ID set to the job executed by the job execution unit 32c and the authentication result information representing that the authentication unit 32b has normally authenticated the user.

The communication unit 32f receives the job from the printing management server 20, and transmits the printing instruction to the other printing devices 30. Also, the communication unit 32f can transmit and receive various information between the printing management server 20 and the other printing devices 30.

Here, as the other printing devices 30, a process in which the printing device 30(2) is assumed is as follows.

For example, the authentication unit 32b of the printing device 30(2) determines whether the group ID and the authentication result information received from the printing device 30(1) are respectively matched with the group ID and the authentication result information set to the job extracted from the storage unit 33 that the printing device 30(2) has. And, for the matched group ID and the matched authentication result information, the job execution unit 32c that the printing device 30(2) has automatically executes the job. In this way, the distributed printing on the printing device 30(1) and the printing device 30(2) is enabled.

### The Hardware Configuration of the Printing Device

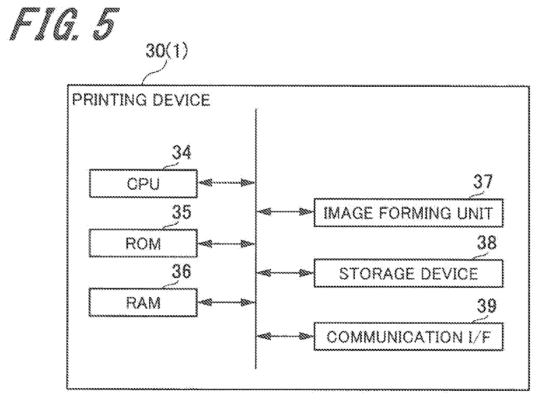

FIG. 5 is a hardware configuration diagram illustrating the configuration example of the main portion of the printing device 30(1). It should be noted that the illustration and description of the other printing devices 30(2) to 30(4) having the same configuration as the printing device 30(1) are omitted.

The printing device 30(1) includes a CPU 34, a ROM 35, a RAM 36, an image forming unit 37, a storage device 38, and a communication interface 39, and is used as a so-called computer. Each unit in the printing device 30(1) is connected via a bus.

The functions of the control unit 32 illustrated in FIG. 4 are achieved by operating the CPU 34, the ROM 35, and the RAM 36. Thus, the control unit 32 is used as an example of a computer controlling the operation of each unit in the printing device 30(1).

The CPU 34 reads the program code of software achieving each function according to the present embodiment from the ROM 35, and executes the processes of the job reception unit 32a, the authentication unit 32b, the job execution unit 32c, the display control unit 32d, the notification unit 32e, and the communication unit 32f, which are illustrated in FIG. 4. Also, the CPU 34 controls, for example, the image forming process (printing operation) of the image forming unit 37 on the basis of the printing instruction of the user performed through the operation display unit 31.

The ROM 35 is used as an example of a nonvolatile memory, and stores the program, data, and the like necessary for the CPU 34 to operate.

The RAM 36 is used as an example of a volatile memory, and temporarily stores information (data) necessary for each process performed by the CPU 34.

The image forming unit 37 forms an image on a sheet by the control unit of the CPU 34, and performs a series of image forming processes (printing) for fixing the image onto the sheet.

The storage device 38 includes, for example, an HDD, and stores the program for the CPU 34 to control each unit, and the program and data of the OS, the controller, and the like. Portions of the program and the data stored in the storage device 38 are stored also in the ROM 35. The ROM 35 and the storage device 38 are used as an example of a non-transitory recording medium storing a computer readable program executed by the CPU 34. It should be noted that the non-transitory recording medium storing the computer readable program executed by the printing management server 20 is not limited to the HDD, and may be, for example, a recording medium, such as an SSD, a CD-ROM, and a DVD-ROM. In the storage device 38, the job storage region 33a, the group ID storage region 33b, the user authentication information storage region 33c, and the like, which are illustrated in FIG. 4 are provided.

The communication interface 39 includes an NIC, a modem, and the like, establishes the connection to each device via the network 2, and executes the transmission and reception of various data. The operation of the communication interface 39 is controlled by the communication unit 32f illustrated in FIG. 4.

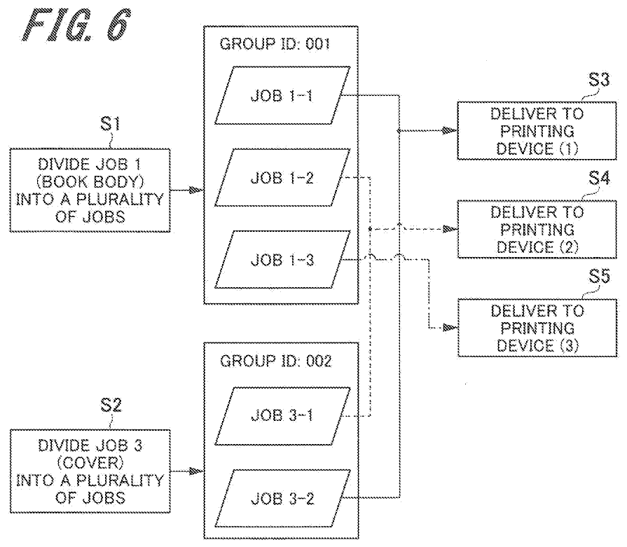

Next, the division process of the job and the process for grouping a plurality of jobs according to the present embodiment will be described with reference to FIGS. 6 to 8.

FIG. 6 is an explanatory view illustrating an example of the process for dividing the job to transmit the divided jobs to the plurality of printing devices 30. This process is performed by the printing management server 20. For this process, the process for dividing the secure job for delivery will be described.

First, the job division unit 21b of the printing management server 20 divides a job 1 (book body) read from the storage unit 22 into a plurality (for example, three) of jobs (S1). Here, the job 1 is a job for printing the book body of a certain book. Then, for example, the job 1 is divided into three: divided jobs 1-1, 1-2, and 1-3. As the group ID of the divided jobs 1-1, 1-2, and 1-3, for example, “001” is assigned.

Next, the job division unit 21b divides a job 3 (cover) read from the storage unit 22 into a plurality (for example, two) of jobs (S2). Here, the job 3 is a job for printing the front cover or the back cover. And, for example, the job 3 is divided into two: divided jobs 3-1 and 3-2. As the group ID of the divided jobs 3-1 and 3-2, for example, “002” is assigned.

In this way, when the job division unit 21b divides the job, the information setting unit 21c assigns the group ID to each divided job. It is found that the divided job to which the same group ID is assigned has the relationship properties (for example, the child having the same parent). It should be noted that the information assigned to the divided job may be an identifier other than the group ID.

Next, the distributed printing instruction unit 21e delivers the jobs 1-1 and 3-2 to the printing device 30(1) (S3), delivers the jobs 1-2 and 3-1 to the printing device 30(2) (S4), and delivers the job 1-3 to the printing device 30(3) (S5).

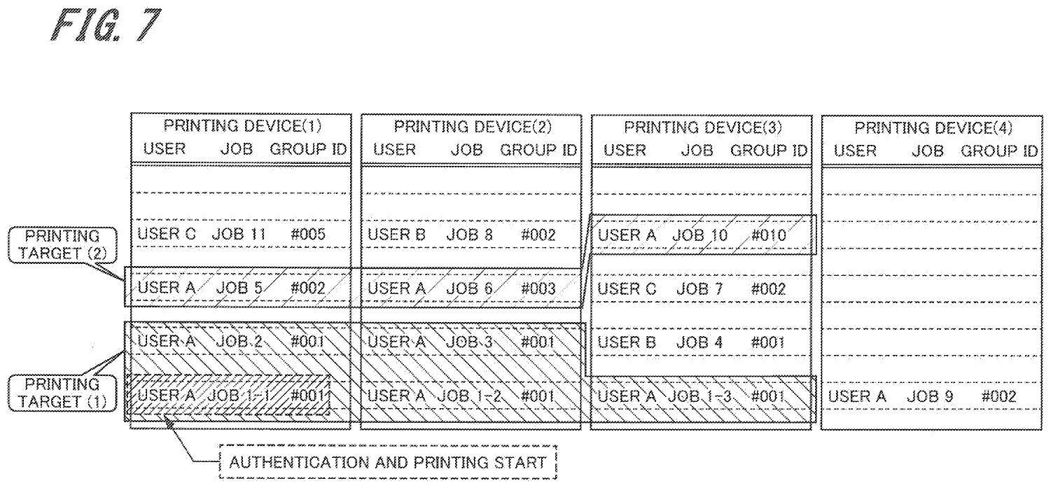

FIG. 7 is an explanatory view illustrating an example of the divided jobs distributed to the plurality of printing devices 30 and the groups thereof.

Here, when the plurality of jobs are distributed and stored in the plurality of printing devices 30, how the printing target is decided will be described. Accordingly, it is assumed that the divided job or the undivided job are delivered to each of the printing devices 30(1) to 30(4), and are accumulated in the queue of the storage unit 33. In the following description, when not discriminated, the divided job and the undivided job are also simply called “job”. Since for example, the queue is operated by FIFO (First In, First Out), the jobs accumulated in the queue are taken out in succession from the lower side of the drawing, and are executed.

First, as the authentication information, only the jobs to which the user A is set are noted for description.

In the queue of the printing device 30(1), the jobs 1-1, 2, and 5 are stored. In the queue of the printing device 30(2), the jobs 1-2, 3, and 6 are stored. In the queue of the printing device 30(3), the jobs 1-3 and 10 are stored. The queue of the printing device 30(4), the job 9 is stored.

The job 4 to which a user B is set is stored in the printing device 30(3), and the job 8 to which the user B is set is stored in the printing device 30(2).

The job 7 to which a user C is set is stored in the printing device 30(3), and the job 11 to which the user C is set is stored in the printing device 30(1).

The job is selected to which the distributed printing is instructed by the distributed printing instruction unit 21e, the job having the user that is the same as the user who introduces the job that is a start point and to which the group ID that is the same as the group ID set to the job that is the start point is set. For example, when the user A performs the user authentication by the printing device 30(1), the job that is the start point is, for example, the first selected job when the user instructs the distributed printing. Thus, the job 1-1 stored in the printing device 30(1) is selected as the job that is the start point. When the user A selects the job 1-1, other jobs (the jobs 1-2, 1-3, 2, and 3) in which the group ID assigned to the job 1-1 is “001” are automatically decided as a printing target (1).

Also, in FIG. 7, a printing target (2) indicated by being enclosed by a frame having diagonal lines downward to the left therein represents that with the job that can be executed by the printing device 30 decided by the printing target (1), the job of the user A that is the same user ID can also be executed. Thus, in the printing devices 30(1) to 30(3) executing the jobs having the group ID “001”, the jobs 5, 6, and 10 to which the user A is set are also decided as the printing target (2) by the distributed printing instruction unit 21e, although having the different group IDs.

On the other hand, “001” that is the same group ID as the printing target (1) is not set to the job 9, and the job 9 is not the job stored in the printing device 30 decided by the printing target (1), so that the job 9 does not have the relationship properties with both of the printing targets (1) and (2). Thus, the job 9 is not the printing target.

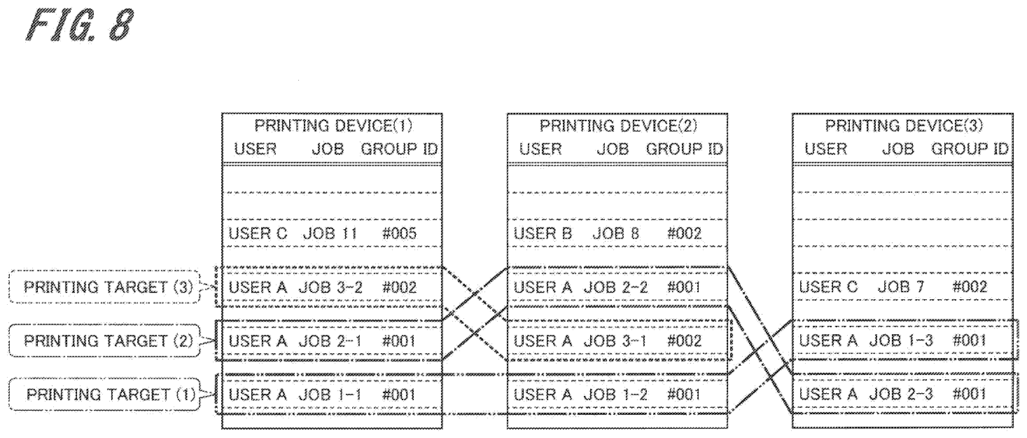

FIG. 8 is an explanatory view illustrating an example in which the jobs accumulated in the queues are not arranged in the job ID order.

When the divided jobs are delivered from the printing management server 20 to the plurality of printing devices 30, the divided jobs are not always accumulated in the queues in the printing order.

For example, as represented by the printing target (1), another job 1-2 to which the group ID that is the same as the group ID “001” set to the job 1-1 selected by the user A is set is arranged in the first in the queue of the printing device 30(2), and the job 1-3 is arranged in the second in the queue of the printing device 30(3).

Also, as represented by the printing target (2), another job 2-2 to which the group ID that is the same as the group ID “001” set to the job 2-1 selected by the user A is set is arranged in the third in the queue of the printing device 30(2), and the job 2-3 is arranged in the first in the queue of the printing device 30(3).

Also, as represented by a printing target (3), another job 3-2 to which the group ID that is the same as the group ID “002” set to the job 3-1 of the printing device 30(2) is set is arranged in the third in the queue of the printing device 30(1).

When the order of the divided jobs accumulated in the queue for each printing device 30 is not the job ID order in this way, the printing order in the queue is adjusted so that the divided jobs are outputted in each divided job unit. For example, the rearrangement in the queue, the editing of the printing order list, the setting of the priority to the job, and the like are performed.

Thus, the display control unit 32d transmits the information related to the job selected as the start point through the operation display unit 31 to the printing management server 20. And, the distributed printing instruction unit 21e of the printing management server 20 instructs the rearrangement of the output order of other jobs to which the group ID matched with the group ID set to the job is set and other jobs selected as the printing target on the printing device 30.

With this, for example, the rearrangement is performed such that in the printing device 30(3), the job 1-3 is the first in the queue and the job 2-3 is the second in the queue. Likewise, the rearrangement is performed such that in the printing device 30(2), the job 2-2 is the second in the queue and the job 3-1 is the third in the queue.

By rearranging the divided jobs in the queue in this way, the jobs printed by each printing device 30 are arranged in the job ID order. And, the job execution unit 32c executes the jobs in the job ID order. Thus, it is possible to eliminate the trouble in which after coming and going between the printing devices 30(1) to 30(3) to collect the printed sheets, the user A rearranges the order of the sheets.

### The Process Example of the Distributed Printing

Next, the process of the distributed printing according to the present embodiment will be described.

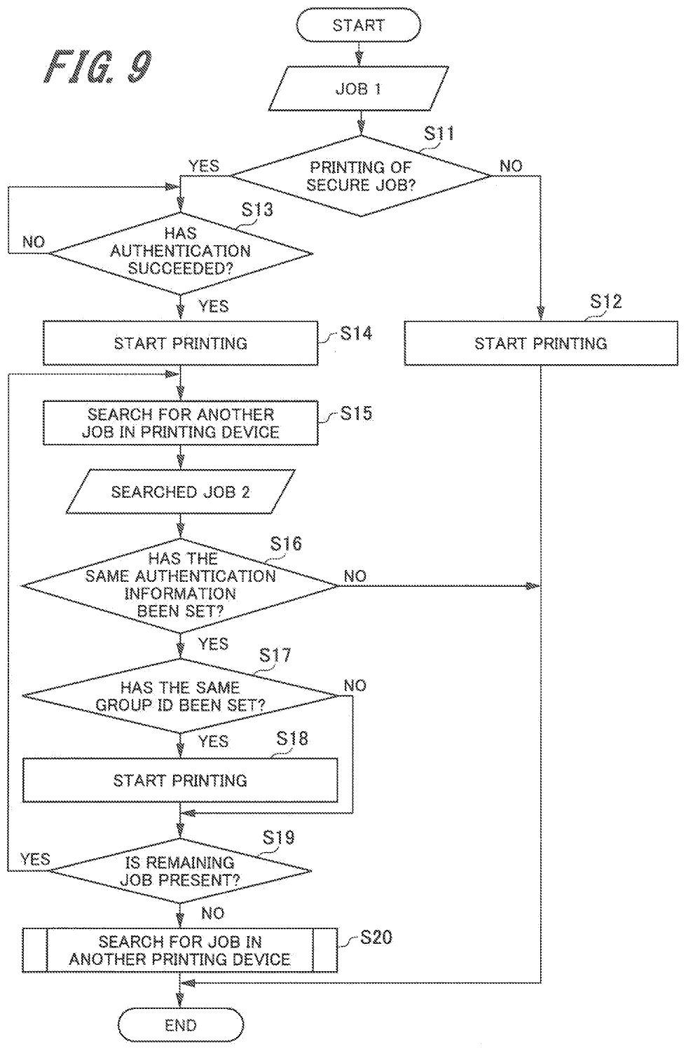

FIG. 9 is a flowchart illustrating an example of the process performed by each device of the distributed printing system 1. Here, an example in which the printing device 30(1) performs a printing process will be mainly described. In this process, the printing device 30(1) automatically executes the job to which the same user authentication information and the same group ID are set, thereby performing printing.

Before the start of this process, the job reception unit 32a of the printing device 30(1) is in a state where it has already received the job 1. The job execution unit 32c determines whether or not the secure job has been designated to the received job 1 (S11). When the secure job has not been designated to the job 1 (No in S11), the job 1 is the typical job, so that the job execution unit 32c executes the job 1 to start printing (S12), thereby ending this process.

When the plurality of printing devices 30 cooperatively perform the distributed printing, the user operates one printing device 30 selected from among the plurality of printing devices 30 to start the printing of the job. Thus, when the secure job has been designated to the job 1 (YES in S11), the authentication unit 32b determines, on the basis of the user authentication information inputted from the operation display unit 31, whether or not the authentication has succeeded (S13). At this time, the user inputs the user authentication information including the user name and the password on the GUI (Graphical User Interface) screen displayed on the operation display unit 31 of that printing device 30. It should be noted that in the following description, the secure job is simply called “job”.

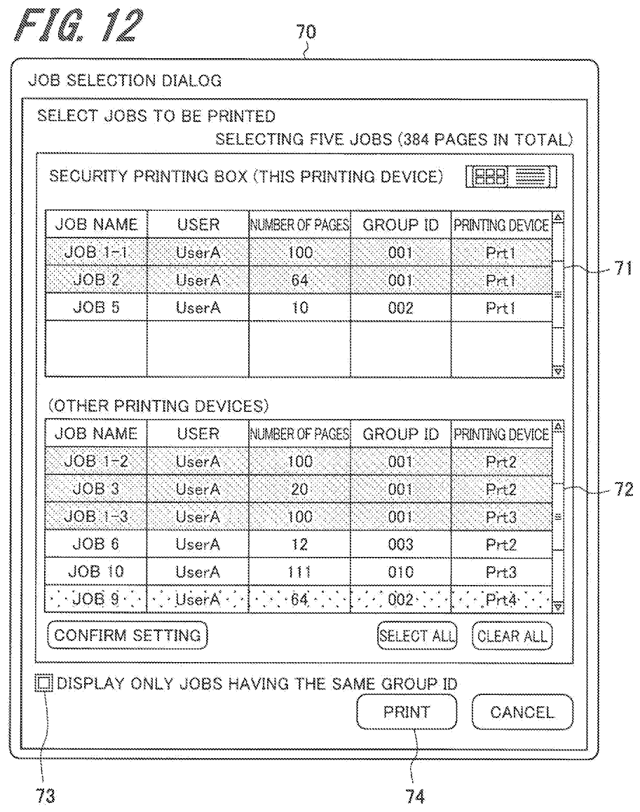

When the authentication unit 32b determines that the authentication has not succeeded (NO in S13), the printing of the job is not started, and the process in step S13 is repeated. When the authentication unit 32b determines that the authentication has succeeded (YES in S13), the list of the jobs to which the user ID of the authenticated user is set is displayed on the operation display unit 31. The user selects the job to be printing started from the displayed job list, and depresses a printing start button 74 displayed on the screen (see FIG. 12 described later). With this, the job 1 to be actually outputted by the printing device 30 operated by the user is decided, and the job execution unit 32c starts the printing of the job (S14).

At this time, the job to which the same user authentication information and the same group ID as the job 1 to which the user instructs the printing start are set is searched for from among the plurality of jobs stored in the printing device 30 operated by the user (S15). And, the job execution unit 32c allows the searched job to be the printing target.

Also, when the user presses the printing start button 74, the printing device 30 that the user is operating transmits, through the network 2 to the other printing devices 30, notification information representing that the printing of the job 1 has been started. In addition to the user authentication information of the job 1, that is, the user ID and the password, the group ID is added to this notification information.

Here, as the destination information on the network 2 of the other printing devices 30, an MIB (Management Information Base) may be used. Also, the printing device 30 present on the network 2 may be registered to the printing management server 20 to refer to the registration information, thereby using the registration information for transmitting the notification information, and the certain printing device 30 may request the printing management server 20 to transfer the notification information to the other printing devices 30.

Also, the information that the certain printing device 30 transmits to the other printing devices 30, in particular, the user authentication information, is desirably transmitted and received by the secure protocol, such as an HTTPS (Hypertext Transfer Protocol Secure) and an SSH (Secure Shell), from the viewpoint of the security. Also, the information itself may be encoded or hashed to further enhance the safety.

In that case, as one form of the process, the process may be divided and executed such that the printing device 30 transmits the user authentication information to the other printing devices 30 when the user authentication information is inputted to the operation display unit 31 of the printing device 30, and further transmits the start information of the job including the group ID when the printing device 30 starts printing. However, when the inputted user authentication information is incorrect, of course, the printing of the job is not started, so that only when the authentication has succeeded, the printing device 30 performs the transmission to the other printing devices 30.

FIG. 9 will be described again.

As described above, the job execution unit 32c searches for another job stored in the storage unit 33 (S15), and reads the searched job 2 from the storage unit 33. And, the job execution unit 32c determines whether the same user authentication information as the already printed job 1 has been set to the searched job 2 (S16). When the same user authentication information as the job 1 has not been set to the job 2 (NO in S16), this process is ended.

On the other hand, when the same user authentication information as the job 1 has been set to the job 2 (YES in S16), the job execution unit 32c determines whether the same group ID as the already printed job 1 has been set to the job 2 (S17). When the same group ID as the job 1 has not been set (NO in S17), the job execution unit 32c moves to step S19.

On the other hand, when the same group ID as the job 1 has been set (YES in S17), the job execution unit 32c starts the printing of the job 2 (S18). Next, the job execution unit 32c determines whether or not the remaining job is present in the storage unit 33 (S19). When the remaining job is present (YES in S19), the job execution unit 32c returns to step S15, and continues the process for executing the job to perform the remaining printing.

On the other hand, when the remaining job is absent (NO in S19), the job execution unit 32c accesses another printing device 30(2) to search for the job stored in the other printing device 30(2) (S20). Also, the job execution unit 32c notifies, to the printing management server 20, that the printing process in the printing device 30(1) has been completed. Thereafter, this process is ended.

It should be noted that for convenience of the description, the job execution unit 32c of the printing device 30(1) accesses only the other printing device 30(2) in step S20. However, the job execution unit 32c may access all the printing devices 30 managed by the printing management server 20 and connected to the network 2 and search for the jobs.

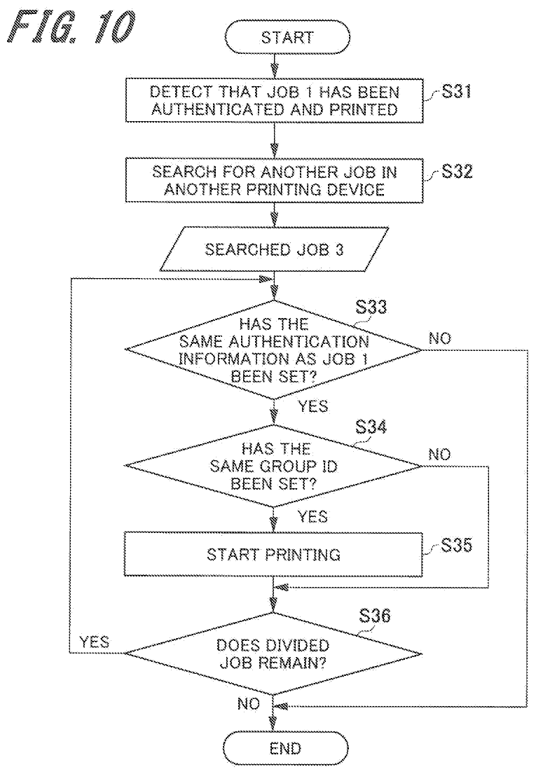

FIG. 10 is a flowchart illustrating an example of the process of the printing management server 20 and the other printing device 30(2). This process is performed after the process of the printing device 30(1) illustrated in FIG. 9.

First, the distributed printing instruction unit 21e of the printing management server 20 detects, on the basis of the notification (execution information) received from the printing device 30(1), that the job 1 has been authenticated and printed (S31). Next, the distributed printing instruction unit 21e searches for another job stored in the other printing device 30(2) (S32). At this time, it is assumed that as the other job to which the same group ID as the already printed job 2 is set, the job 3 is stored in the storage unit 33.

Then, the authentication unit 32b of the printing device 30(2) determines whether the same user authentication information as the already printed job 1 has been set to the searched job 3 (S33). When the same user authentication information as the job 1 has not been set to the job 3 (NO in S33), this process is ended.

On the other hand, when the same user authentication information as the job 1 has been set to the job 3 (YES in S33), the authentication unit 32b determines whether the same group ID as the job 1 has been set to the job 3 (S34). When the same group ID as the job 1 has not been set to the job 3 (NO in S34), the job execution unit 32c moves to step S36.

On the other hand, when the same group ID as the job 1 has been set to the job 3 (YES in S34), the job execution unit 32c starts printing on the basis of the job 3 (S35). Then, the job execution unit 32c determines whether or not the remaining divided job is present in the storage unit 33 (S36). When the remaining divided job is present (YES in S36), the job execution unit 32c returns to step S33, and continues the process for executing the job to perform the remaining printing.

On the other hand, when the remaining divided job is absent (NO in S36), the job execution unit 32c notifies, to the printing management server 20, that the printing process on the printing device 30(2) has been completed. Thereafter, this process is ended.

In this way, when receiving the information related to the job 1 transmitted by the process of the printing device 30(1), the other printing device 30(2) executes the necessary process, such as decoding, to the received information, and then searches for the job stored in the storage unit 33 to start printing.

It should be noted that the process illustrated in FIG. 10 may be performed by the other printing device 30(2) alone. Also, in FIG. 10, the process of the printing management server 20 and the other printing device 30(2) has been described, but also on the printing device 30(3) and the like other than the other printing device 30(2), the same process as FIG. 10 is performed in parallel.

Also, when the printing device 30(1) separately transmits the user authentication information and the group ID at different timings, first, the other printing device 30(2) holds the list of the jobs having the matched user authentication information. Thereafter, when receiving the group ID, the other printing device 30(2) selects the job having the same group ID from the held list to allow the job to be the printing target, and executes the responding process to the printing device 30(1).

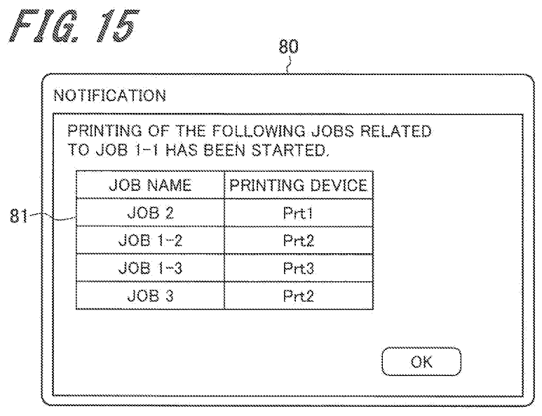

When these processes are automatically executed, it is desirable to notify, to the user, on a result display screen (see FIG. 15 described later), whether some response has been performed to the printing device 30 to which the job that is the start point has been designated, that is, whether the printing of the job has been started. That is, when receiving the information from the printing device 30(1) to start printing, the other printing device 30(2) returns the information, such as the job ID and the name of the job in which printing has been started, to the printing device 30(1) that is the transmission source, or the printing management server 20, and when the printing target is absent, the other printing device 30(2) responds back a message representing the printing target is absent (notification representing that printing has not been performed, and the like). However, when the distributed printing system 1 performs the process totally automatically, the user may feel annoyed with respect to the notification representing that printing has not been performed, so that such the notification is not necessary.

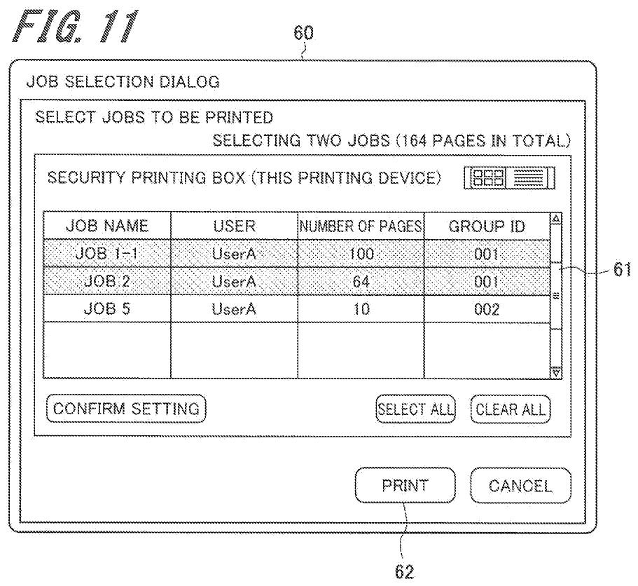

Next, the configuration example of the screen displayed on the operation display unit 31 of the printing device 30 will be described with reference to FIGS. 11 to 15.

FIG. 11 is a user interface diagram illustrating the display example of a selection screen 60 for the typical job.

The selection screen 60 is provided with an own device job display unit 61 that displays, as the information of the job stored in the printing device 30(1) operated by the user, the respective items of the job name, the user, the number of pages, and the group ID. The user confirms the information of the job displayed on the own device job display unit 61, and selects the job to be executed by the printing device 30(1). The job selected by the user or selected by the printing management server 20 from the instruction of the distributed printing instruction unit 21e is highlighted by changing the color. This example represents that the jobs 1-1 and 2 having the group ID identified by “001” have been selected.

The selection screen 60 displays only the jobs stored in the printing device 30(1), among the jobs united by the group ID. And, the user performs the operation of pressing a printing start button 62 to instruct the job execution, and the printing device 30(1) then performs the job execution to start printing. Also, when the operation of pressing the printing start button 62 is performed on the printing device 30(1), other jobs stored in any one of the other printing devices 30(2) to 30(4) and identified by the group ID are automatically selected to start printing.

FIG. 12 is a user interface diagram illustrating the display example of a selection screen 70 capable of displaying the jobs stored in the other printing devices 30(2) to 30(4).

As a form for further enhancing the convenience of the user using the selection screen 60 illustrated in FIG. 11, the selection screen 70 illustrated in FIG. 12 is considered. The selection screen 70 does not automatically start the printing of the jobs other than the job 1, unlike the selection screen 60, and can displays the list of the jobs that are the printing target before the start of printing.

The selection screen 70 displays the respective items of the job name, the user, the number of pages, and the group ID, like the selection screen 60 illustrated in FIG. 11, and also displays the printing device name that is the name of each printing device 30 connected to the network 2. The selection screen 70 displays the jobs that are the printing target, not only for the printing device 30(1) displaying the selection screen 70, but also for the other printing devices 30(2) to 30(4).

The selection screen 70 is provided on its upper side with an own device job display unit 71 displaying the information of the jobs stored in the printing device 30(1) displaying the selection screen 70. The own device job display unit 71 includes, in addition to the items of the job name, the user, the number of pages, and the group ID, the item of the printing device. And, in the item of the printing device, “Prt1” representing the printing device 30(1) is displayed.

The selection screen 70 is provided on its lower side with an other device job display unit 72 displaying the information of the jobs stored in the other printing devices 30(2) to 30(4). The items displayed on the other device job display unit 72 are the same as the items displayed on the own device job display unit 71. And, with the information of the jobs stored in the other printing devices 30(2) to 30(4), “Prt2” to “Prt4” representing the printing devices 30(2) to 30(4) are displayed in the item of the printing device.

Below the other device job display unit 72, a checkbox 73 used for the user to instruct the display of only the jobs having the same group ID is provided. In FIG. 12, the checkbox 73 is in the unchecked state. In this state, the information of the jobs having the group IDs (“003” and “010”) other than the group IDs (“001” and “002”) set to the jobs stored in the printing device 30(1) is also displayed on the other device job display unit 72.

When the user manually selects the jobs 1-1 and 2 identified by the group ID “001” on the printing device 30(1), the jobs 1-2, 3, and 1-3 identified by the group ID “001” of the other printing devices 30(2) to 30(4) are also automatically selected, and are highlighted by changing the color. In this way, the selection screen 70 displays the jobs to which the same user and the same group ID as the job (1-1) that is stored in the printing device 30(1) displaying the selection screen 70 and is the start point are set and stored in the other printing devices 30(2) and 30(3), the jobs being brought into the selectable state.

In this way, by the selection screen 70, the list of the jobs having the same authentication information for all the printing devices 30 that the distributed printing system 1 has can be displayed on the printing device 30(1). Further, the printing device 30(1) allows the job having the same group ID (the job that is a printing start target) to be brought into the selection state by a default, so that the job having the same group ID can be represented so that the user can easily recognize the job.

On the selection screen 70, the user can set the job to be actually printed. For example, this setting is performed by the operation such that the user clicks the job in the listing displayed list to add the job as the printing target and to delete the job from the printing target. The operation display unit 31 displays, on the screen, that the job to which the particular group ID is set is the printing target, and receives the addition or deletion of the job included in the printing target by the operation input of the user.

When before the execution of the job, the display control unit 32d displays, on the screen, the list of the jobs that are the printing target, the display control unit 32d changes the display form (for example, the display color) of other jobs to which the group ID matched with the group ID set to the job selected as the start point by the user is set and other jobs to which the non-matched group ID is set, and displays the jobs on the operation display unit 31. Thus, the user can confirm, on the screen, both of the job that is the printing target and the job that is not the printing target.

It should be noted that a plurality of jobs identified by the same group ID may be automatically selected and be executed. However, by displaying the selected jobs on the selection screen 70 once, the user can perform the operation of confirming the job that is the printing target, adding other jobs to the printing target, and deleting the jobs from the printing target. Also, the job having the different group ID is not the printing target automatically selected, but the user can also arbitrarily add the job to the printing target.

The job 9 that does not have the relationship properties with the currently selected jobs is gray displayed on the other device job display unit 72. For example, the group ID “002” of the job 9 is different from the group ID “001” of the printing device 30(1) displayed on the own device job display unit 71. And, the job 9 is stored in the printing device 30(4) illustrated in FIG. 7. Accordingly, the job 9 is gray displayed, and is represented to have no relationship properties with the currently selected jobs. It should be noted that the job 9 itself may be non-displayed from the list. Also, when the user confirms that the job 9 is present on the printing device 30(4) to allow the printing device 30(4) to print the job, the job 9 can also be selected as the printing target.

In this way, in order that the printing device 30(1) displays the jobs stored in the other printing devices 30(2) to 30(4), in the printing process of the secure job in the flowcharts illustrated in FIGS. 9 and 10, each of the processes in steps S14, S18, and S35 of “start printing” is required to be changed to “register to list as printing start target”. For example, the list represents the arrangement of the jobs united for each printing target in order to display the list of the jobs on the selection screen 70. And, after the respective flowcharts illustrated in FIGS. 9 and 10 are ended, the list of the jobs registered to the list as the printing start target is displayed on the selection screen 70.

Thereafter, the job execution unit 32c executes the jobs included in the printing target to start printing. The start of printing may be performed such that the user presses the printing start button 74, or may be automatically performed.

To achieve the function of the selection screen 70, for example, when the printing device 30(1) performs the user authentication with respect to the job 1, the user authentication information authenticated as valid is transmitted to the other printing devices 30(2) to 30(4). When any one of the other printing devices 30(2) to 30(4) receiving the user authentication information stores the job to which the same user authentication information is set, it responds back the information related to the job (the job ID, the job name, and the group ID) to the printing device 30(1).

However, the user authentication information and the information related to the job may be transmitted and received via the printing management server 20 without being transmitted and received between the plurality of printing devices 30. Also, the printing management server 20 may hold the list of the jobs delivered to each printing device 30, and respond back, to the printing device 30(1), the job to which the user authentication information matched with the user authentication information received from the printing device 30(1) is set.

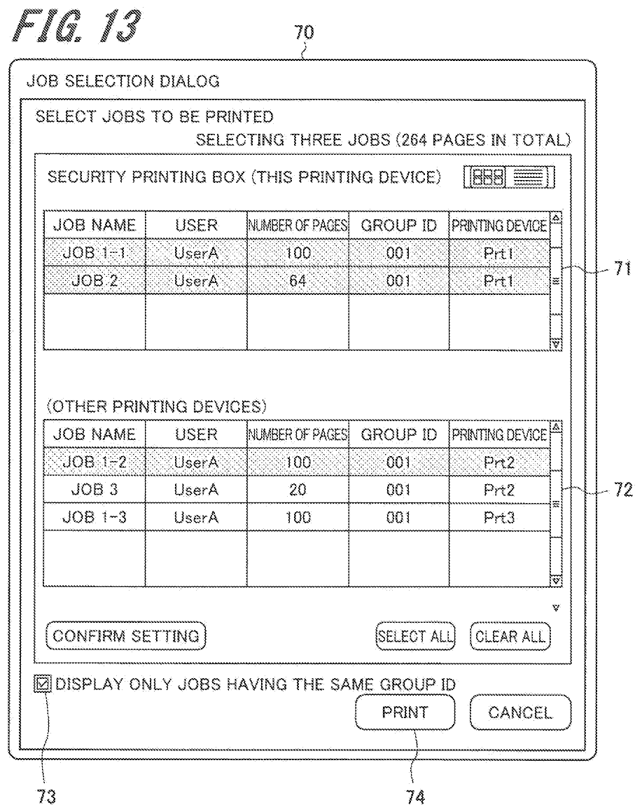

FIG. 13 is a user interface diagram illustrating the display example of the selection screen 70 displaying only the jobs having the same group ID.

When the number of jobs stored in the printing device 30(1) is large, a large number of jobs are displayed on the operation display unit 31, so that the user is difficult to select the job. Thus, when the checkbox 73 is checked, the display control unit 32d can execute filtering for displaying only the jobs having the group ID selected by the user on the own device job display unit 71 and the other device job display unit 72.

For example, when the user selects the job having the group ID “001” on the own device job display unit 71, only the jobs having the group ID “001” among the jobs stored in the other printing devices 30(2) and 30(3) are automatically selected and displayed on the other device job display unit 72. By allowing the jobs having the different group IDs to be non-displayed in this way, the user can confirm only the jobs allowed to be the printing target and having the same group ID.

Here, when performing the user authentication, the printing device 30(1) is not allowed to transmit the user authentication information to the other printing devices 30(2) to 30(4). And, after the printing device 30(1) determines that the user authentication information is valid, and further, at the timing at which the job is selected by the user, the printing device 30(1) transmits the user authentication information and the group ID of the selected job to the printing devices 30(2) to 30(4). And, the other printing devices 30(2) to 30(4) respond back, to the printing device 30(1), only the information of the jobs having the same group ID. With this, unnecessary communication between the respective printing devices 30 can be reduced.

There is the case where the printing devices 30(2) to 30(4) executing the jobs having the matched user authentication information and the matched group ID store the jobs to which the same user authentication information is set and having the different group ID. However, even when the group ID of the job introduced by the user authenticated on the printing device 30(1) is different, the printing devices 30(2) to 30(4) may allow the jobs to be the printing target. For example, this is because the relationship properties in which the printing device 30(1) printing the job 1-1 can print the job 1-1, and can also print other jobs are present. And, the other printing devices 30(2) to 30(4) respond back the job information to the printing device 30(1) printing the job that is the start point, so that the printing device 30(1) can display, to the user, the job that is the printing target, and set the job addition or deletion.

Also, the printing of the job having the same group ID and delivered to the different printing device 30 can be automatically executed as the printing target. The printing devices 30(2) to 30(4) printing the jobs are also the collection target of the printed sheets. Thus, when the jobs to which the same group ID is set are printed on the printing devices 30(2) to 30(4), the user goes to the printing devices 30(2) to 30(4) to collect the printed sheets. Thus, the security problem in which the printed sheets are seen by other users moving close to the printing devices 30(2) to 30(4) is not caused.

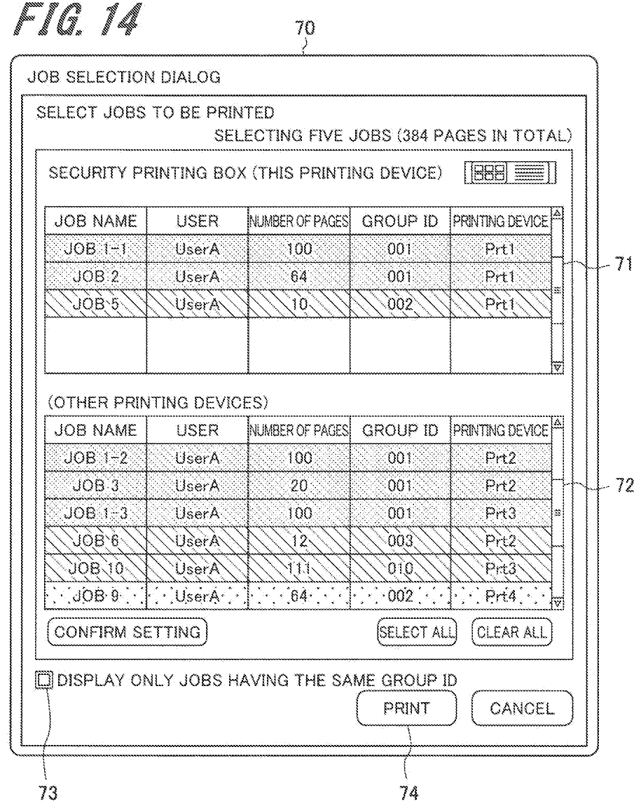

FIG. 14 is a user interface diagram illustrating the display example of the selection screen 70 displaying the jobs to which the same group ID as the job that is the start point is set and the jobs related to the job that is the start point.

When the selection screen 70 displays the jobs that are the printing target, the job to which the group ID that is the same as the group ID set to the job that is the start point is set and the job that is the printing target irrespective of having the different group ID are different. Accordingly, on the selection screen 70 illustrated in FIG. 14, in order that the user can easily discriminate the jobs that are the printing targets, the jobs are displayed by changing the display form (the display color and the like) for the respective printing targets.

The selection screen 70 illustrated in FIG. 14 represents that when the job 1-1 that is the start point is selected on the printing device 30(1), the job 2 having the same group ID “001” as the job 1-1 is displayed on the own device job display unit 71. Also, the jobs 1-2, 3, and 1-3 having the same group ID “001” as the job 1-1 are displayed on the other device job display unit 72.

Since the checkbox 73 is not checked, the jobs 6, 10, and 9 having the group IDs different from the group ID “001” are also displayed on the other device job display unit 72. Here, the jobs 6 and 10 are the jobs that can be executed on the printing devices 30(2) and 30(3) represented as “Prt2” and “Prt3”, respectively, operated when the jobs having the group ID “001” are executed. Accordingly, the information of the job 6 and the information of the job 10 are displayed in the color different from the color of the jobs to which the group ID “001” is set. Thus, the user recognizes that the jobs 6 and 10 have been printed on the printing devices 30(2) and 30(3), respectively, and when going to the printing devices 30(2) and 30(3) to collect the printed sheets having the group ID “001”, the user can also collect the printed sheets having the group IDs “003” and “010”.

However, the printing device 30(4) that can execute the job 9 is located at a place different from the place of the printing devices 30(1) to 30(3) at which the user makes a stop to collect the printed sheets. Consequently, it cannot be determined whether when the user makes a stop at the printing devices 30(1) to 30(3), he/she also makes a stop at the printing device 30(4). Thus, the job 9 is displayed in the color different from the colors of other jobs.

It should be noted that in the display form of the selection screen 70 illustrated in FIGS. 12 to 14, the information of the job having the same group ID and the information of the job having the relationship properties irrespective of having the different group ID are displayed in the different colors, but the display form that can discriminate these information may be adopted for the selection screen 70. For example, the display form may be such that the other device job display unit uniting only the jobs having the relationship properties is newly provided, and the list of the jobs displayed on the other device job display unit 72 is separated to display the jobs. Also, the selection screen 70 may be of the display form that performs tab display for each of the information of the job having the same group ID, the information of the job having the relationship properties irrespective of having the different group ID, and the information of the job without the relationship properties.

FIG. 15 is a user interface diagram illustrating the display example of a printing result screen 80.

After the job execution, the display control unit 32d performs control to display, on the screen, the list of the jobs executed by the job execution unit 32c and the list of the printing devices 30 that have executed the jobs. For example, the printing result screen 80 in which the display is controlled by the display control unit 32d includes a printing start job display unit 81 displaying the items of the job name and the printing device name. When the printing of the job selected on the selection screen 70 is automatically started, the names of the started job and the printing device 30 that has started the printing of this job are displayed on the printing result screen 80. The user confirms the job name and the printing device name displayed on the printing start job display unit 81, and can thus grasp the printing device 30 and the job in which printing has been started. It should be noted that the printing result screen 80 may be displayed during the job execution.

In the distributed printing system 1 according to an embodiment described above, to perform the distributed printing that secures the security, first, the user inputs the user authentication information (the user name, the password, and the like) on the particular printing device 30(1). And, when the printing of part of the distributed printing is started on the printing device 30(1), the printing of other jobs to which the user authentication information and the group ID matched with the user authentication information and the group ID received from the printing device 30(1), respectively, are set is started also on the other printing devices 30(2) to 30(4). In this way, the other printing devices 30(2) to 30(4) can determine, on the basis of two elements of the user authentication information and the job group ID, whether the other jobs are allowed to be the printing target.

However, when the printing device 30 that stores the job to which the same user authentication information is set and having the different group ID has already been in charge of printing, it may start the printing of the job having the different group ID. Even when the job having the different group ID has been started, the printing of the job that the printing device 30 has already been instructed to perform printing is started, so that the user comes to this printing device 30 to collect the printed sheets. Thus, the security problem in which the outputted printed sheets are left and their contents are seen by other users is not caused. With this, all the jobs having the same user authentication information present on the plurality of printing devices 30 are not printed, but only the jobs having the relationship properties can be printed by securing the security.

Also, when a plurality of jobs are distributed to and stored in the plurality of printing devices 30, it is not appropriate to start printing in the order in which the jobs are accumulated in the queues, depending on the timing at which the respective printing devices 30 receive the jobs. Thus, the jobs in the queues are replaced such that printing is performed in the job number order. With this, the jobs are printed in succession (for example, in the job ID order), so that the trouble in which the user rearranges the sheets printed by the printing device 30 can be eliminated.

According to the present embodiment, a job having the user authentication information that is the same as the user authentication information set to a job and having the relationship properties with respect to this job is executed on the printing device designated by the user to enable the distributed printing to be performed, thereby improving the convenience of the distributed printing.

### Modification

It should be noted that in the distributed printing system 1 according to the abovementioned embodiment, after the user operates the client PC 10 to execute the introduction process of the job, the job is sent to the printing management server 20. And, after determining the relationship properties between the jobs, the printing management server 20 assigns the group ID, if necessary, and sends the divided jobs to the plurality of printing devices 30 to which the distributed printing is designated. However, when the distributed printing is performed on the basis of one job, it is also possible to divide the job on the client PC 10, deliver the divided jobs to the plurality of printing devices 30, and instruct the distributed printing. In this case, the configuration of the client PC 10 is the same configuration as the printing management server 20. Thus, even when the printing management server 20 is removed from the distributed printing system 1, the client PC 10 can set the relationship properties between the divided jobs, and can transmit the group ID to the plurality of printing devices 30.

Also, in the distributed printing system 1 according to the abovementioned embodiment, the information is transmitted from the printing device 30(1) printing the job that is the start point, toward the other printing devices 30(2) to 30(4), and the printing devices 30 side that has received the information further performs the job searching process for reply. However, the printing device 30(1) may transmit job list reply requests to the other printing devices 30. In this case, after receiving the job lists from the other printing devices 30, the printing device 30(1) may search for the job having the same user authentication information and the same group ID in the printing device 30(1). And, the printing device 30(1) may display, on the screen of the operation display unit 31, the determination result obtained by determining whether the job is allowed to be the printing start target.

Also, the printing device 30(1) may transmit a request to execute the job searching and the printing start target determination, to the printing management server 20 managing the plurality of printing devices 30, and receive the result. In this case, the printing management server 20 transmits the job list reply requests to the other printing devices 30, executes the job searching and the printing start target determination, and then, transmits, to the printing device 30(1), the job lists that are the determination results, as the response to the reply requests.

It should be noted that the present invention is not limited to the abovementioned embodiment, and of course, various application examples and modifications can be taken as long as they do not depart from the purport of the present invention described in the claims.

For example, to simply describe the present invention, in the abovementioned embodiment, the configurations of the devices and the system have been specifically described in detail, and the present invention does not necessarily include all the described configurations. Also, part of the configuration of the embodiment described here can be replaced with the configurations of other embodiments, and further, the configuration of a certain embodiment can be added with the configurations of other embodiments. Also, part of the configuration of each embodiment can also be subjected to the addition, deletion, and replacement with respect to other configurations.

Also, the control lines and the information lines that are considered to be necessary for the description are represented, and all the control lines and the information lines are not necessarily represented for the product. It may be considered that actually, almost all the configurations are mutually connected.

### LIST OF REFERENCE SIGNS

1 . . . distributed printing system, 20 . . . printing management server, 21a . . . job management unit, 21b . . . job division unit, 21c . . . information setting unit, 21d . . . job delivery unit, 21e . . . distributed printing instruction unit, 30 . . . printing device, 31 . . . operation display unit, 32a . . . job reception unit, 32b . . . authentication unit, 32c . . . job execution unit, 32d . . . display control unit, 32e . . . notification unit, 32f . . . communication unit

What is claimed is:

1. A distributed printing system comprising:
a printing management server; and
a plurality of printing devices connected to the printing management server via a network,
wherein the printing management server has:
an information setting unit setting, to a plurality of jobs to which the user authentication information of a user who has introduced a job is set and having relationship properties, relationship information shared among the plurality of jobs;
a job delivery unit delivering the different jobs to the respective plurality of printing devices; and
a distributed printing instruction unit instructing, to the printing device designated by the user among the plurality of printing devices, distributed printing on the basis of the job having the matched relationship information,
wherein each of the printing devices includes:
a storage unit storing the job received from the job delivery unit;
an authentication unit authenticating the user on the basis of the inputted user authentication information; and
a job execution unit extracting, from the storage unit, the job to which the user authentication information matched with the user authentication information authenticated as valid by the authentication unit and the matched relationship information are set, and executing the job.

2. The distributed printing system according to claim 1,
wherein the printing management server has a job division unit dividing the job,
wherein the information setting unit sets the user authentication information and the relationship information to each of the divided jobs,
wherein the job delivery unit delivers the divided jobs to the plurality of printing devices.

3. The distributed printing system according to claim 2,
wherein the printing device has a notification unit notifying, to the printing management server, execution information related to the job executed by the job execution unit,
wherein when the user authentication information and the relationship information set to the job executed by the job execution unit and the user authentication information and the relationship information set to other jobs are matched on the basis of the execution information notified from the printing device, the distributed printing instruction unit of the printing management server instructs the distributed printing on the basis of the other jobs to other printing devices to which the other jobs have been delivered.

4. The distributed printing system according to claim 2,
wherein the printing device has a notification unit notifying, to the other printing devices, the relationship information set to the job executed by the job execution unit and authentication result information representing that the authentication unit has normally authenticated the user,
wherein when in the other printing devices, the relationship information and the authentication result information received from the printing device are matched with the relationship information and the authentication result information set to the jobs extracted from the storage units that the other printing devices have, the job execution units that the other printing devices have execute the jobs.

5. The distributed printing system according to claim 1,
wherein the information setting unit sets the relationship information on the basis of at least one or more information among the execution validity or invalidity of the distributed printing with respect to the job, the name of the job, the user authentication information set to the job, the time at which the printing instruction has been performed, the document information of the job, the printing setting information, and the information of a client terminal that has introduced the job.

6. The distributed printing system according to claim 1,
wherein the printing device has:
an operation display unit receiving an operation input from the user and displaying the job stored in the storage unit; and
a display control unit controlling a screen displayed on the operation display unit,
wherein the job execution unit determines, on the basis of the contents of the operation input, whether or not the job to which the same user authentication information is set is executed.

7. The distributed printing system according to claim 6,
wherein on the basis of the contents of the operation input, the display control unit performs selection to display or not to display, as a printing target, the job to which the same user authentication information is set.

8. The distributed printing system according to claim 6,
wherein the display control unit notifies, to the printing management server, that the relationship information has been set to the job designated by the operation input,
wherein the job execution unit executes the job to which the relationship information is set, and starts printing.

9. The distributed printing system according to claim 6,
wherein before the execution of the job, the display control unit performs control to display, on the screen, the list of the jobs that are the printing target.

10. The distributed printing system according to claim 6,
wherein the operation display unit displays, on the screen, that the job to which the relationship information is set is the printing target, and receives the addition or deletion of the job included in the printing target by the operation input.

11. The distributed printing system according to claim 6,
wherein the display control unit changes the display form of the other jobs to which the relationship information matched with the relationship information set to the job selected as a start point by the user is set and the other jobs to which the non-matched relationship information is set, and allows the operation display unit to perform display.

12. The distributed printing system according to claim 6,
wherein the display control unit transmits, to the printing management server, information related to the job selected as the start point through the operation display unit,
wherein the printing management server instructs the rearrangement of the output order of the other jobs to which the relationship information matched with the relationship information set to the job is set and the other jobs selected as the printing target on the printing device,
wherein the job execution unit of the printing device rearranges the jobs according to the instruction to execute the jobs.

13. The distributed printing system according to claim 6,
wherein the job execution unit instructs the other printing devices to execute the jobs in which the user authentication information and the relationship information are matched with the user authentication information and the relationship information set to the job to be executed, respectively, the jobs being stored in the other printing devices.

14. The distributed printing system according to claim 6,
wherein during or after the execution of the job, the display control unit performs control to display, on the screen, the list of the executed jobs and the list of the printing devices that have executed the jobs.

15. An information processing device comprising:
an information setting unit setting, to a plurality of jobs to which the user authentication information of a user who has introduced a job is set and having relationship properties, relationship information shared among the plurality of jobs;
a job delivery unit delivering the different jobs to the respective plurality of printing devices connected via a network; and
a distributed printing instruction unit instructing, to the printing device designated by the user among the plurality of printing devices, distributed printing on the basis of the job having the matched relationship information.
